(19) United States
(12) Patent Application Publication
(10) Pub. No.: US 2019/0156269 A1
(43) Pub. Date: May 23, 2019

(54) LIQUID COLOR MANAGEMENT METHODS

(71) Applicant: Maguire Products, Inc., Aston, PA (US)

(72) Inventor: Paul Sherwood MAGUIRE, Thornton, PA (US)

(73) Assignee: Maguire Products, Inc., Aston, PA (US)

(21) Appl. No.: 16/258,870

(22) Filed: Jan. 28, 2019

Related U.S. Application Data
(62) Division of application No. 14/472,490, filed on Aug. 29, 2014.
(60) Provisional application No. 61/872,082, filed on Aug. 30, 2013.

(51) Int. Cl. G06Q 10/08; B29C 31/06

(52) U.S. Cl. CPC G06Q 10/083; B05B 9/04; B29C 31/06

(57) ABSTRACT

A method for managing the supply of liquid color to a process machine utilizes an electronic memory device connected permanently to a container of liquid color and an electronic memory controller that interacts with the electronic memory device, preferably wirelessly over the Internet.

### CROSS-REFERENCE TO RELATED PATENT APPLICATION

This patent application is a 35 USC 121 division of U.S. patent application Ser. No. 14/472,490, filed 29 Aug. 2014 in the name of Paul Sherwood Maguire, which in turn claimed priority from U.S. provisional application Ser. No. 61/872,082 filed 30 Aug. 2013 in the name of Paul Sherwood Maguire. The instant application claims the priority from both the '490 application and the '082 application under 35 USC 120.

### BACKGROUND OF THE INVENTION

In the plastics industry liquid color is one alternative to providing color in fabricated plastic parts. (Solid colorants, added to the resin mix prior to extrusion or molding, are the other alternative.)

This application is concerned with liquid color as used in the plastics industry.

Liquid color is sold in drums, pails, totes, or other liquid tight containers. This application makes reference to a “drum” or “drums” of liquid color. As used in this application, “drum” means any type of container in which liquid color is sold and delivered to a plastics fabricator.

Similarly, as used herein molding presses and extruders used by plastics fabricators are collectively referred to as “process machines”.

A manufacturer of liquid color mixes two or more single pigment dispersions to provide the precise shade of liquid color required by a customer, who is generally a plastics fabricator. The precise color shade may often be proprietary for a given customer.

### SUMMARY OF THE INVENTION

In one of its aspects, this invention provides apparatus for storage and shipment of liquid color where the apparatus includes a container and an electronic memory device connected to the container. The electronic memory device is preferably physically connected to the container and is more preferably even permanently connected to the container. The electronic memory device may be built into the container. Desirably, the electronic memory device is selected from the group comprising flash drives, thumb drives, memory chips and integrated circuit chips.

In another aspect of this invention, the invention provides a method for furnishing liquid color to a plastic resin process machine to fabricate finished or semi-finished plastic parts of a prescribed color from a liquid color container having an electronic memory associated therewith. In this aspect of the invention, the invention proceeds with loading the electronic memory with information relating to the liquid color in the container with the information including the weight of the container when full and when empty, and the pounds per gallon and density information for the liquid color in the container.

The invention proceeds by metering a pre-determined weight of liquid color on a machine cycle-by-machine cycle basis, from the liquid color container to a process machine. The invention further proceeds desirably by continuously sensing weight of the liquid color container from which the liquid color is being drawn, computing the average loss of weight of liquid color by the container per process machine cycle, and adjusting the pre-determined weight of the container on the basis of average loss of weight of the liquid color container for each process machine cycle.

In yet another one of its aspects, this invention provides a method for managing the supply of liquid color to a process machine, commencing with providing a container of liquid color having an electronic device physically connected to the container. The invention proceeds with loading the electronic memory device with information relating to liquid color in the container, the information including identification of the color, the quantity of liquid color in the container, weight of the container when empty and when full, and the weight density of the liquid color, desirably in pounds per gallon.

This method aspect of the invention then proceeds by providing liquid color to a process machine from the container as the process machine produces plastic parts. The method proceeds with weighing the container when the supply of liquid color to the process machine has been concluded, and thereafter computes the quantity of liquid color consumed by the process machine by subtracting the weight of the color, when supplying of liquid color has finished, from the container weight stored in the electronic memory device and converting such weight difference to pounds of liquid color consumed.

This method aspect of the invention may further include providing liquid color to the process machine, comparing identification of color in the electronic device with a pre-selected color specified for the plastic parts, and rejecting the container of liquid color if the identification of color in the electronic device differs from the pre-selected color.

Desirably the color identification comparison is performed electronically by the electronic device. The electronic device most desirably comprises an electronic memory and an electronic controller, and in this aspect of the invention the method may further include providing the amount of liquid color consumed as information to a central facility computer where the liquid color consumed is preferably provided in pounds of liquid color.

The following detailed description is merely exemplary in nature and is not intended to limit the described embodiments of the invention or uses of the described embodiments. As used herein, the words “exemplary” and “illustrative” mean “serving as an example, instance, or for illustration.” Any implementation or embodiment or abstract disclosed herein as being “exemplary” or “illustrative” is not necessarily to be construed as preferred or advantageous over other implementations, aspects, or embodiments. All of the implementations or embodiments described in the detailed description are exemplary implementations and embodiments provided to enable persons of skill in the art to make and to use the implementations and embodiments as disclosed below, to otherwise practice the invention, and are not intended to limit the scope of the invention, which is defined by the claims.

Furthermore, by this disclosure, there is no intention on the part of the Applicant to be bound by any express or implied theory presented in the preceding materials, including but not limited to the summary of the invention or the description of the prior art, or in the following detailed description of the invention. It is to be understood that the specific implementations, devices, processes, aspects, and the like illustrated in the attached drawings and described in the following portion of the application, usually referred to as the “specification,” are simply exemplary embodiments of the inventive concepts defined in the claims. Accordingly, specific dimensions and other physical characteristics relating to the embodiments disclosed herein are not to be considered as limiting as respecting the invention unless the claims or the specification expressly state otherwise.

### BRIEF DESCRIPTION OF THE DRAWINGS

FIG. 1 is a schematic representation of apparatus adapted for practicing the methods of the invention.

### DETAILED DESCRIPTION OF THE INVENTION AND BEST MODE FOR PRACTICE

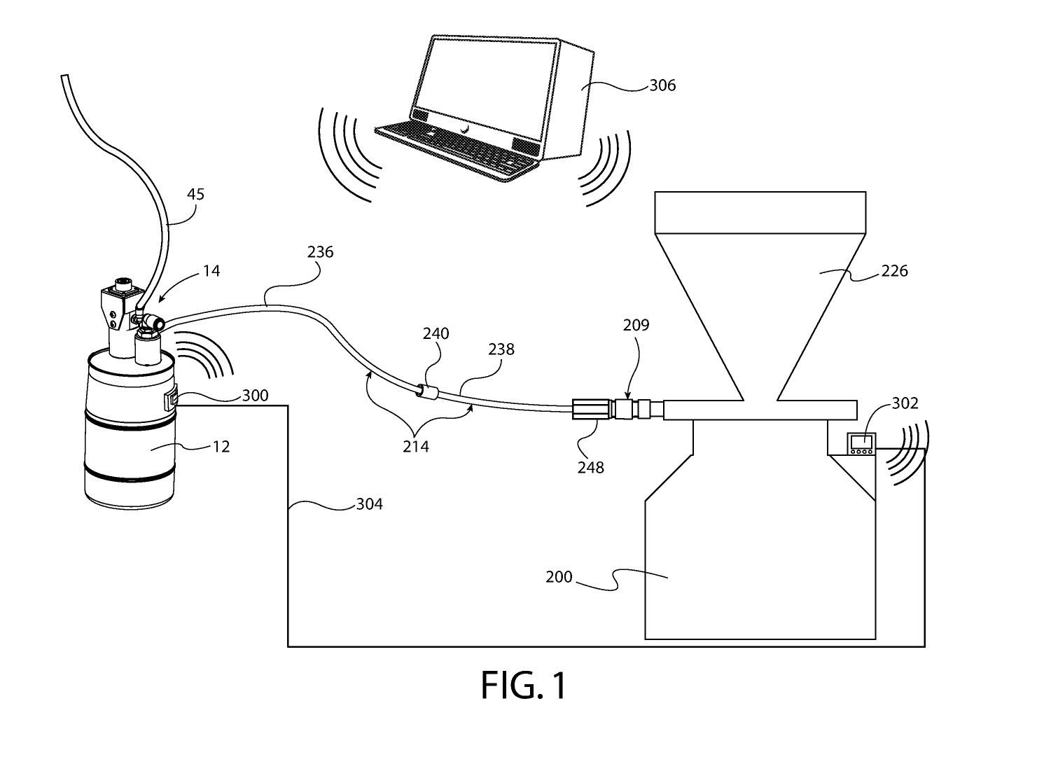

Referring to FIG. 1, a color conveying tube designated generally 214 connects the outlet of a liquid color pump 14, which draws liquid color from a container 12 of liquid color for delivery to a process machine 200. Desirably, a quick disconnect tubular shutoff female portion 248 is on the outlet end of the color conveying tube 214. With the quick disconnect tubular shutoff female portion 248 in place on the outlet end of the color conveying tube 214, when color conveying tube 214 is disconnected from a color feed conduit assembly 209 (preferably consisting of an aluminum relatively rigid outer color delivery support tube and a preferably Teflon fluoropolymer flexible inner color delivery tube), color conveying tube 214 desirably seals shut and no liquid color can drip therefrom.

When the color needs to be changed, color conveying tube 214 can be disconnected from color feed conduit assembly 209 without any drip of liquid color. A short length of the preferably Teflon fluoropolymer inner color delivery tube remains within process machine 200, inside the preferably aluminum outer color delivery support tube, and is purged by the new liquid color as the new liquid color is introduced into the inner color delivery tube.

Liquid color pump 14 is preferably powered by air pressure and is desirably used to pump liquid color out of a liquid color container 12 through color conveying tube 214 and further through a preferably Teflon fluoropolymer inner color delivery tube residing within an aluminum outer color delivery support tube also residing in process machine 200. If preferably Teflon fluoropolymer inner color delivery tube is removed, the quick disconnect non-drip female portion of the coupling desirably closes, sealing the color conveying tube. There is no risk of building up too much pressure in the color conveying tube 214 or the aluminum outer color delivery support tube, since pressure of liquid color in the system is inherently limited to the pressure of the air furnished via air supply line 45 to drive liquid color pump 14.

In the drawing, process machine 200 is illustrated in schematic form as an injection molding press and includes a screw within a barrel, which is not shown in FIG. 1. Process machine 200 further includes a feed throat opening above the barrel. Plastic resin pellets to be molded into a finished or semi-finished plastic product are fed from a hopper 226 downwardly through the feed throat into the barrel for plasticizing conveyance by a screw into a mold. These components are not shown in the drawing.

Liquid color flow to process machine 200 commences with pump 14 pumping liquid color from a drum 12 through color conveying tube 214 into flexible inner color delivery tube 212 portion of color feed conduit assembly 209. A first portion 236 of liquid color conveying tube 214 is preferably connected to an outlet from pump 14 by a barbed fitting, which in turn has been desirably screwed into a quarter-turn connector portion of pump 14. Liquid color conveying tube 214, particularly first segment 236 thereof, is desirably pressed on to the barbed fitting. At the other outlet end of liquid color conveying tube 214 is another barbed fitting, which is desirably screwed into a female quick disconnect, which in turn desirably pushes onto a male quick disconnect.

As illustrated in FIG. 1 schematically, liquid color conveying tube 214 may have two or more segments; two are illustrated in FIG. 1.

Liquid color pump 14 may be of the type disclosed in co-pending U.S. patent application Ser. No. 13/913,375 filed 7 Jun. 2013. Other equally suitable liquid color pumps for use as pump 14 are disclosed in U.S. Pat. Nos. 7,416,096; 7,390,119; 7,980,834; and 7,958,915. The disclosures of all of these patents and patent applications are incorporated by reference.

Liquid color conveying tube 214 has a quick disconnect shut-off installed on the outlet, where that shut-off is desirably a quick disconnect non-drip female connector portion 248 in FIG. 1. When connector 248 is disconnected from a counterpart connector, connector 248 seals shut and liquid color cannot drip from the outlet of liquid color conveying tube 214.

When the color needs to be changed, liquid color conveying tube 214 can be disconnected without liquid color dripping due to the presence of non-drip female connector portion 248 on the end of tube 214. A short length of color delivery tubing that remains in machine 200 is within a rigid outer color delivery support tube and is purged by the new color flowing therein.

Liquid color conveying tube 214 is preferably ⅜ inch inside diameter polyethylene tubing, which is secured to the outlet of pump 14 by pressing on to a barbed fitting.

At the outlet end of liquid color conveying tube 214, for connection with quick disconnect non-drip female connector portion 248, is another barbed fitting that screws into quick disconnect non-drip female connector portion 248. (This barbed fitting has not been illustrated in the drawings, to enhance drawing clarity.) Presence of quick disconnect non-drip female connector portion 248 assures no drip of liquid color when liquid color conveying tube 214 is disconnected from color feed conduit assembly 209 and hence from process machine 200.

It is desirable for a liquid color customer to be able to verify or “proof” the shade or hue of liquid color delivered in a container 12, before the container is connected to the process machine 200 and the liquid color begins to flow from container 12 to machine 200, with colored plastic parts resulting (which are the color shade or hue of the liquid color coming out of container 12).

To provide the liquid color customer with assurance that the fabricated plastic parts will be the correct color, this invention provides methods and apparatus for automatically electronically checking that the furnished liquid color is the correct color for that particular customer's process machine making specific plastic parts. This automatic electronic checking eliminates any chance of human error whereby a container of the wrong liquid color could be connected to the process machine and

In one of its aspects this invention provides the combination of a liquid color container 12 and an electronic memory 300 that, when used with one or more appropriate metering system controllers 302 or microprocessors, not only provides electronic checking to eliminate any chance of a customer connecting the wrong container of liquid color to the customer's process machine, but also facilitates electronic monitoring and recording of process machine consumption of liquid color so that liquid color inventory can be tracked and adjusted automatically, based on process machine consumption.

In one preferred practice of the invention, an electronic memory device 300 is permanently connected to a liquid color container 12. The electronic memory device may be a “flash drive”, or a “memory chip”, or a “thumb drive”, or any other suitable electronic device that includes memory, preferably read/write memory. Typically, the electronic memory device is a passive device having a memory which can be read by a suitable active electronic device and which can receive and store new data supplied by a suitable device.

While the invention is preferably largely concerned with use of passive electronic memory devices affixed to containers of liquid color, use of active electronic memory devices is also within the scope of the invention.

The electronic memory device 300 is preferably connected permanently to the liquid color container 12. Tethering may be used to affix the electronic memory device 300 to the liquid color container 12. More desirably, the electronic memory device 300 may be built into the liquid color container 12 in a manner that the electronic memory device 300 cannot be removed from the liquid color container 12 without destroying or impairing operation of the electronic memory device 300. Such construction is depicted in FIG. 1.

Most desirably, the liquid color container 12 includes an integral pump 14 which is permanently connected, or at least partially connected to, or is disconnectable from, the liquid color container 12.

The electronic memory device 300 is adapted to have information concerning the contents of the liquid color container loaded into it by the liquid color manufacturer. The information most typically includes the color identifier, which is preferably an alphanumeric code and preferably known only to the manufacturer/seller of the liquid color in the liquid color container. (The liquid color container is typically and desirably owned by the manufacturer/seller of the liquid color.) The electronic memory device 300 further is adapted to have loaded into it the date of manufacture of the liquid color in the liquid color container 12, the lot number of the liquid color contained in the liquid color container 12, the original or starting quantity of liquid color in the liquid color container 12, and the weight of the liquid color stored in the container 12, usually expressed in pounds per gallon of liquid.

The electronic memory device 300 is preferably connected, when the liquid color is to be dispensed, to a metering system controller 302, which is desirably located at least adjacent to the process machine. (In FIG. 1, the metering system controller 302 has been depicted as being monitored on the process machine 200). The metering system controller 302 confirms all of the pertinent information, namely the color identifier, the date of manufacture of the liquid color, the lot number of the liquid color, the starting quantity of liquid color in the container, and the weight density of the liquid color (typically in pounds per gallon of liquid) by communicating with electronic memory device 300 and reading the relevant data therefrom. Communication between memory device 300 and metering system controller 302 can be by hardwire as indicated by line 304 in FIG. 1, or may be wireless, preferably via the Internet, as also indicated schematically by the Internet wireless symbols provided in FIG. 1. The metering system controller 302 then records this information in its own memory, or in the memory of an associated computer 306, and dynamically tracks usage of liquid color as the liquid color is pumped from the container and supplied to the process machine.

When accessed electronically by the metering system controller 302, the electronic memory device 300 has data confirming that the liquid color container 12 connected to the process machine 200 contains the correct color for the particular plastic parts being manufactured. The metering system controller 302 is desirably first furnished with work order information as to the particular parts being fabricated, with such information being input to the metering system controller 302 by the operator of the process machine, either automatically or manually. The metering system controller 302, using the data for the liquid color that is encoded in the electronic memory device 300, confirms that the color coming from the liquid color container 302 is correct for the particular parts being manufactured by comparing the work order information input to metering system controller 302 with the liquid color information read from electronic memory device 300.

This invention provides a major commercial benefit in that “proofing” assures the purchaser of the liquid color that the liquid color having been delivered is of the correct hue for the parts being made. In the course of practice of the “proofing” procedure, the metering system controller 302 communicates electronically with the memory device 300, with metering system controller 302 reading data from memory device 300, where that data includes a color identification code used by the particular liquid color manufacturer, the date of manufacture of the liquid color contained in liquid color container 12, the lot number as supplied by the liquid color manufacturer, the quantity of liquid color in container 12 at delivery and the weight of the liquid color in pounds per gallon. The “proofing” occurs when the metering system controller 302, either being manually actuated or being automatically actuated by pre-programming of suitable memory contained therein, communicates with the memory device 300 and compares the data read from the memory device 300, namely the color identifier, the date of manufacture of the liquid color, the lot number of the liquid color, the original quantity of liquid color in the container, and the weight of the liquid color in pounds per gallon, with data that has been input to the metering system controller 300 by the purchaser of the liquid color, which data is based on information supplied by the liquid color seller to the purchaser when the order for liquid color was placed with the liquid color seller.

If metering system controller 302 detects any variance between the data read from the electronic memory device 300 and the data supplied by the liquid color seller (this data is, as noted above, supplied by the seller upon placement of the order by the entity manufacturing the plastic parts and using the liquid color to color those parts), metering system controller 302 raises a flag, stops the procedure so that the disparity can be investigated, and if the liquid color is of the wrong color or quantity, the situation may be corrected. If, however, metering system controller 302 finds that all of the data read from electronic memory device 300 corresponds correctly to the data supplied by the liquid color manufacturer to the buyer upon placement of the order, then the manufacturing procedure is allowed to proceed.

The information stored by the electronic memory device 300 may be transferred directly to a central computer 306 that tracks color usage in a particular manufacturing facility on a facility-wide basis. Alternatively, the information initially stored in the electronic memory device 300 and optionally modified by the metering system controller 302 (and then dynamically stored in the electronic memory device 300) as the process machine 200 operates may also be then transferred from the metering system controller 302 to a central computer 306 for tracking facility-wide color usage.

It is further within the scope of this invention to use a portable data gathering device, such as a smart phone or a tablet equipped with a reader, which may be handheld or otherwise, to download and store data directly from the electronic memory device 300 of each liquid color container. Cellular telephones of the “smart” type that are equipped with a scanner capability may be used to communicate with the electronic memory devices 300 associated with liquid color containers in the manufacturing facility. This permits an operator in the facility to check each liquid color container and its operation “on the spot” by downloading the data from an electronic memory device 300 into the operator's cellular telephone and thereafter transmitting that data via e-mail or otherwise to a central computer or other databank that monitors and operates the plastics fabricating facility.

It is further within the scope of this invention to gather data from the liquid color container electronic memory device 300 and from the metering system controller 302 using a dedicated connection to a central computer, where that dedicated connection may be either hardwired or wireless, preferably using Wi-Fi over the Internet, as depicted schematically in FIG. 1. Desirably, usage of liquid color as the liquid color is consumed by the plastic parts manufacturing process is tracked on a loss of weight basis, with the liquid color container being weighed periodically, or more desirably continuously, as the liquid color is furnished to the process machine. As the weight of the liquid color container decreases, this decrease in weight is converted into either pounds or gallons of liquid color; that information is recorded in electronic memory device 300. In such a way, the electronic memory device 300 always contains correct data as to the amount of liquid color in the liquid color container to which electronic memory device 300 is affixed.

The data in electronic memory device 300 is downloaded to that device when the liquid color is placed into the liquid color container 12. Hence the manufacturer of the liquid color has control over and responsibility for the accuracy of the data in electronic memory device 300.

The memory system controller 302, having continual access to the data in the electronic memory device, preferably monitors decrease in weight of the liquid color container 12. This permits the manufacturing operation to check that the charge for the liquid color in dollars is for the amount of liquid color actually used in the course of the process.

Desirably, communication between the electronic memory device 300 and the metering system controller 302 is wireless, over the Internet.

Use of such an electronic memory device 300 such as a thumb drive, a flash drive, a memory stick, or the equivalent, as a way to identify each specific liquid color container and to make data for that particular liquid color container available to either the metering system controller 302 or a central computer at the time the liquid color is about to be used, eliminates human error, which could result in the wrong color being used, with defective and unacceptable parts resulting.

During operation, the electronic memory device 300 may store progressively adjusted weight information, supplied by the metering system controller 302, as the liquid color is used by the process machine. Using information from the electronic memory storage device 300 to define initial conditions and then measuring the amount of liquid color dispensed from the liquid color container, by measuring loss of weight of the container to determine the amount of liquid color used by the process machine, is facilitated using the invention. The metering system controller may operate on a stand-alone basis or may be directly connected to central computer 306 that monitors the operation of the entire plastics processing facility. Desirably the metering system controller 302 has memory allowing metering system controller 302 to gather data from electronic memory device 300 connected to the liquid color container 12. The memory capability of metering system controller 302 allows the data to be downloaded later to central computer 306 for tracking color usage on a plant-wide basis.

It is further within the scope of the invention to furnish liquid color to a process machine to fabricate finished or semi-finished plastic parts of a prescribed color by (i) metering a pre-determined weight of liquid color, on a machine cycle-by-machine cycle basis, to the process machine while continuously sensing weight of the container 12 from which the liquid color is being drawn; (ii) computing the average loss of weight of the liquid color container per process machine cycle; (iii) adjusting the metering to provide a pre-determined weight of liquid color for each process machine cycle; and (iv) recording such usage of the liquid color in the electronic memory device 300 associated with the liquid color container, in order that the supplier-owner of the liquid color container can know how much liquid color was drawn from the liquid color container by the process machine. In this manner, it is not necessary for the owner-operator of the process machine to use all of the liquid color supplied in a given liquid color container. The manufacturer-supplier of the liquid color in the liquid color container can determine from the information in the electronic memory device 300 affixed to container 12 how much liquid color was used from the container, and the owner-operator of the process machine can be charged for only the liquid color consumed on such basis.

Although schematic implementations of present invention and at least some of its advantages are described in detail hereinabove, it should be understood that various changes, substitutions and alterations may be made to the apparatus and methods disclosed herein without departing from the spirit and scope of the invention as defined by the appended claims. The disclosed embodiments are therefore to be considered in all respects as being illustrative and not restrictive with the scope of the invention being indicated by the appended claims rather than by the foregoing description. All changes which come within the meaning and range of equivalency of the claims are therefore intended to be embraced therein. Moreover, the scope of this patent application is not intended to be limited to the particular implementations of apparatus and methods described in the specification, nor to any methods that may be described or inferentially understood by those skilled in the art to be present as described in this specification.

As disclosed above and from the foregoing description of exemplary embodiments of the invention, it will be readily apparent to those skilled in the art to which the invention pertains that the principles and particularly the compositions and methods disclosed herein can be used for applications other than those specifically mentioned. Further, as one of skill in the art will readily appreciate from the disclosure of the invention as set forth hereinabove, apparatus, methods, and steps presently existing or later developed, which perform substantially the same function or achieve substantially the same result as the corresponding embodiments described and disclosed hereinabove, may be utilized according to the description of the invention and the claims appended hereto. Accordingly, the appended claims are intended to include within their scope such apparatus, methods, and processes that provide the same result or which are, as a matter of law, embraced by the doctrine of the equivalents respecting the claims of this application.

As respecting the claims appended hereto, the term “comprising” means “including but not limited to”, whereas the term “consisting of” means “having only and no more”, and the term “consisting essentially of” means “having only and no more except for minor additions which would be known to one of skill in the art as possibly needed for operation of the invention.” The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

The following is claimed:

1. A method for furnishing liquid color to a plastic resin process machine to fabricate finished or semi-finished plastic parts of a prescribed color from a liquid color container having an electronic memory, comprising:
a) loading the electronic memory with information relating to the liquid color in the container, the information including the weight of the container when full and when empty, and the pounds per gallon density for the liquid color in the container;
b) metering a predetermined weight of liquid color, on a machine cycle-by-machine cycle basis, from the liquid color container to a process machine;
c) continuously sensing weight of the liquid color container from which the liquid color is being drawn;
d) computing the average loss of weight of liquid color by the container per process machine cycle;
e) adjusting the predetermined weight in step “b” on the basis of average loss of weight of the liquid color container for each process machine cycle.

2. A method for managing the supply of liquid color to a process machine, comprising:
a) providing a container of liquid color having an electronic device physically connected to the container;
b) loading the electronic device with information relating to liquid color in the container, the information including identification of the color, the quantity of liquid color in the container, weight of the container when empty and when full, and the weight density of the liquid color in pounds per gallon;
c) providing liquid color to a process machine from the container as the process machine produces plastic parts;
d) weighing the container when supply of liquid color to the process machine has concluded;
e) computing the quantity of liquid color consumed by the process machine by subtracting the weight of the container when supply of liquid color has concluded from the container weight stored in the electronic memory device and converting such weight difference to pounds of liquid color consumed.

3. The method of claim 2 further comprising prior providing liquid color to the process machine, comparing the identification of color in the electronic device with a preselected color specified for the plastic parts, and rejecting the container if the identification of color in the electronic device differs from the preselected color.

4. The method of claim 3 wherein the comparison is performed electronically by the electronic device.

5. The method of claim 2 wherein the electronic device comprises an electronic memory and an electronic controller.

6. The method of claim 2 further comprising providing the pounds of liquid color consumed information to a central facility computer.

7. A method for verifying a shipment of liquid color vis-à-vis an order for liquid color having specifications therefor, comprising:
a) loading a container with a batch of liquid color of a given hue;
b) downloading information respecting that batch of liquid color into an electronic memory device affixed to the container;
c) reading the information from the electronic memory device;
d) comparing the information read from the electronic memory device with the liquid color specifications and verifying that the liquid color furnished for the order is correct if the information matches the specifications.

8. The method of claim 7 wherein the information and the specifications both include hue identification.

9. The method of claim 7 wherein the information and specifications both include color number, container contents weight, manufacturer lot number and date of manufacturer of the liquid color.

10. The method of claim 7 where in reading is performed using a portable, handheld device.

11. The method of claim 7 further comprising:
a) dynamically reading the container contents weight from the electronic memory device;
b) recording the dynamically read container contents weight;
c) computing rate of usage of the liquid color from the dynamically recorded container weights; and
d) adjusting inventory of liquid color containers based on computed rate of liquid color usage.
